(19) United States
(12) Patent Application Publication
(10) Pub. No.: US 2008/0143977 A1
(43) Pub. Date: Jun. 19, 2008

(54) Spoke synchronization system and method for an image display system

(75) Inventors: Gregory J. Hewlett, Richardson, TX (US); Kevin M. Chin, Allen, TX (US); Thomas J. Doty, McKinney, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/589,577

(22) Filed: Oct. 30, 2006

(51) Int. Cl. G03B 21/14

(52) U.S. Cl. 353/84

(57) ABSTRACT

In one embodiment, a method for displaying an image comprises moving a color filter through a source light beam, modulating the source light beam into a plurality of image segments, modifying the source light beam to each of the plurality of image segments in a sequential manner such that each particular image segment is off at least when an uncertain region is co-incidental with the particular image segment. The color filter has at least two color filter elements that form at least two interfaces. The uncertain region is created by each interface when moved through the source light beam. The plurality of image segments are contiguously arranged with one another in order to form the image.

### TECHNICAL FIELD OF THE INVENTION

This invention relates to image display systems, and more particularly, to a spoke synchronization system for an image display system and method of operating the same.

### BACKGROUND OF THE INVENTION

Light modulators are a class of devices that may be used to modulate a source light beam into an image suitable for display on a surface. These light modulators may each have a number of spatially oriented refractive or reflective elements that are arranged in a two-dimensional configuration. Examples of such light modulators may include liquid crystal display modulators or digital micro-mirror devices (DMDs). To produce the color image, a color filter may be implemented that alternatively filters the source light beam such that differing colors of the source light beam may be periodically directed to the light modulator.

### SUMMARY OF THE INVENTION

In one embodiment, a method for displaying an image comprises moving a color filter through a source light beam, modulating the source light beam into a number of image segments, and modifying the source light beam to each image segment in a sequential manner when an uncertain region is co-incidental with the particular image segment. The color filter has at least two color filter elements that form at least two interfaces. The uncertain region is created by each interface when moved through the source light beam. The plurality of image segments are contiguously arranged with one another in order to form the image.

In another embodiment, a system for displaying an image comprises a color filter having at least two color filter elements that form at least two interfaces. The color filter is configured to move through a source light beam such that each interface forms an uncertain region upon the image. The system additionally comprises a light modulator operable to modulate the source light beam into a number of image segments. The image segments are contiguously arranged with one another in order to form the image. The light modulator is further operable to modify the source light beam to each image segment when the uncertain region is co-incidental with the particular image segment.

Depending on the specific features implemented, particular embodiments of the present invention may exhibit some, none, or all of the following technical advantages. Various embodiments may be capable of providing a method of increasing the amount of light from the source light beam to be used by the light modulator. In this manner, a corresponding lesser amount of light is wasted by the system, thus making the image display system relatively more efficient. Additionally, a relatively brighter image may be created by the image display system. Other technical advantages will be readily apparent to one skilled in the art from the following figures, description and claims.

### BRIEF DESCRIPTION OF THE DRAWINGS

A more complete understanding of embodiments of the invention will be apparent from the detailed description taken in conjunction with the accompanying drawings in which:

FIG. 1A is a schematic diagram of several components of an image display system that may be used to implement various embodiments of the present invention;

FIG. 1B is one embodiment of a color wheel that may be used with the image display system of FIG. 1A;

FIG. 2 is an illustrative view of an image produced by the image display system of FIG. 1 showing an uncertain region of the image;

FIG. 3 is an illustrative view of an image having a number of image segments that may be produced by the image display system of FIG. 1;

FIG. 4 is a timing diagram showing a series of segment update sequences produced by one embodiment of the image display system of FIG. 1;

FIG. 5 is a timing diagram showing a series of segment update sequences produced by another embodiment of the image display system of FIG. 1;

FIG. 6 is a timing diagram showing a series of segment update sequences produced by yet another embodiment of the image display system of FIG. 1;

FIG. 7 is an alternative embodiment of a color wheel that may be used with the image display system of FIG. 1A;

FIG. 8 is a partial view of the color wheel of FIG. 1B showing how various angular orientations of its associated spoke region creates a corresponding angular orientation error; and

FIG. 9 is a partial view of the color wheel of FIG. 7 showing how various angular orientations of its associated spoke region creates a corresponding angular orientation error.

### DETAILED DESCRIPTION OF EXAMPLE EMBODIMENTS OF THE INVENTION

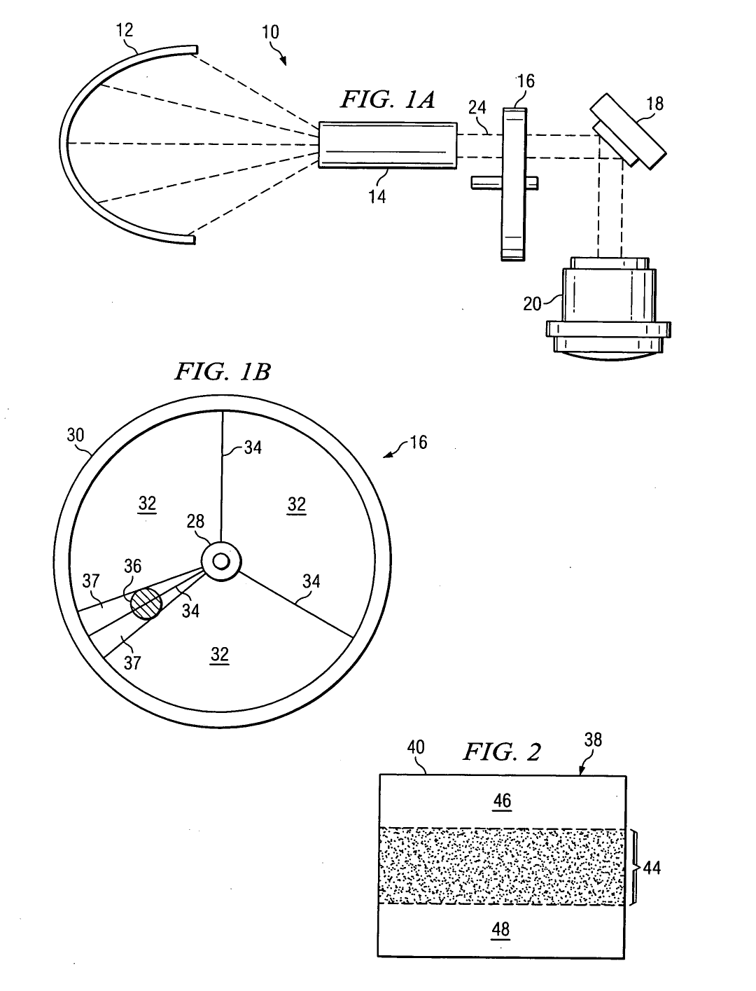

Referring now to the drawings, FIG. 1A shows a schematic diagram of one embodiment of an image display system 10 according to the present invention. The image display system 10 generally includes a light source 12, an optional integrator rod 14, a color wheel 16, a light modulator 18, and a projection lens 20. The light source 12 is configured to produce visible light that may be formed into a source light beam 24 by the integrator rod 14. The source light beam 24 is directed through a color wheel 16 for sequentially filtering of the source light beam 24 into two or more colors. The source light beam 24 is subsequently modulated into a visual image by the light modulator 18 and directed towards the projection lens 20 for display of the image. The image may include a number of pixels arranged in N number of rows by M number of columns, thereby forming the image having a height equal to M* (pixel size) and a width equal to N* (pixel size).

In various embodiments, light modulator 18 may be a spatial light modulator, such as, for example, a liquid crystal display modulator or a digital micro-mirror display modulator (DMD). In this particular embodiment, the light modulator is a DMD. The DMD has a number of reflective elements corresponding to the arrangement and quantity of pixels to be displayed in the image. The digital micro-mirror device has a number of reflective surfaces arranged in an M×N configuration. These reflective surfaces are adapted to selectively reflect light emanating from the source light beam 24 to the projection lens 20. When coordinated together, the reflective surfaces are operable to create an image that is refracted by the projection lens 20 for display upon any suitable planar surface.

Light source 12 may be an incandescent lamp, fluorescent lamp, high-intensity discharge (HID) lamp, light emitting diode (LED), laser, or other suitable light source. Light source 12 may be a single lamp or multiple lamps that are configured to produce light at various wavelengths in the infrared, visible, or ultra-violet spectrum. The image may include different colors by use of any suitable color filter that is adapted to alternatively pass selected colors from the source light beam 24. Color filter may be any suitable reflective or refractive device, such as a rotating mirror, a rotating prism, a rotating color filter, an oscillating optical filter, or other similar device. In the embodiment of FIG. 1, the color filter is a color wheel 16. The color wheel 16 works in conjunction with the source light beam 24 to alternatively direct two or more differing colors of the source light beam 24 toward the light modulator at predetermined time intervals. Given these predetermined time intervals, the light modulator 18 may then proportionally mix each of the colors in order to produce many of the other colors within the visible light spectrum.

FIG. 1B shows one embodiment of the color wheel 16. The color wheel 16 generally includes a hub 28, an outer ring 30, and three generally pie-shaped translucent color filter elements 32. The junction between each of the color filter elements 32 may be referred to as an interface 34. The color filter elements 32 may be operable to filter the source light beam 24 into three distinct colors. In one embodiment, the three color filter elements may each comprise red, green, and blue color filter elements. In another embodiment, the three color filter elements may each comprise yellow, cyan, and magenta color filter elements. In operation, the color wheel 16 is rotated about its hub 28 such that the source light beam 24 alternatively shines through each of the color filter elements 32. Given a generally constant rotational velocity of the color wheel 16, a colored source light beam 24 including each color of the color filter elements may be supplied to the light modulator 18 at regular, periodic intervals. However, because the source light beam's cross-section 36 is not infinitely small as the source light beam 24 shines through color wheel 16 near interface 34, an uncertain color of light including components from adjacent color filter elements is directed to the light modulator 18. Generally, a region of color wheel 16 corresponding to this area of uncertain color of light is often referred to as a spoke region 37. Because this uncertain light is a mixture of colors, it generally cannot be used as distinct colored light for generating an image. Thus, a portion of light that would otherwise be available cannot be used, according to conventional implementations.

Light source 12 may be any suitable device configured to emit light in the visible as well beyond the visible light spectrum, such as ultra-violet or infrared light. Such suitable light sources 12 may include incandescent lights, light emitting diodes (LEDs), lasers, fluorescent lights, and the like. In certain embodiments, it would be desirable for the image display system 10 to efficiently utilize the light emanating from the light source 12. That is, an incremental increase in the effective usage of the light available from the light source 12 may yield a corresponding incremental increase in overall brightness of the resulting image. With a relatively higher brightness, usage of the image display system 10 may be enabled in environments having higher ambient light levels. A relatively higher overall brightness may also reveal details of the image that may not be as ascertainable with a lower overall brightness level. Thus, according to the teachings of the present invention, a system and method is provided for utilizing available light from the source light beam 24 as the interface 34 traverses across the source light beam 24.

FIG. 2 is one embodiment of a two-dimensional image 40 that may be displayed upon a display 38. Movement of the interface 34 through the source light beam 24 creates a corresponding uncertain region 44 that extends horizontally across the image 40. This uncertain region 44 is a design constraint that may be used to synchronize the operation of the image display system 10 with the movement of the uncertain region 44. A design constraint generally refers to a prescribed limitation that may be placed upon any functional component of the image display system 10. In this particular embodiment, the uncertain region 44 specifies a region in which each pixel of the light modulator 18 should be modified at least when any portion of the uncertain region 44 is co-incidental with that particular pixel. In this particular embodiment, the interface has a generally horizontal orientation relative to the image 40. It should be appreciated, however, that the position of the color wheel 16 relative to the source light beam 24 may cause the uncertain region 44 to have any orientation relative to the image 40, such as, for example, a vertical orientation. It may be undesirable to use the portion of the source light beam 24 in this uncertain region 44 because its generally low quality of light may impair the quality of the resulting image. Thus, it may be beneficial to momentarily modify particular pixels of the light modulator 18 when the interface progresses across the source light beam 24. Although the uncertain region may not be used as distinct colored light, it may be used to perform other functions, such as overall brightening of the image, providing color contrast adjustments, and the like.

There are several factors that may cause light within the uncertain region 44 to have an undesirable quality. These other factors may include a spoke angle orientation error, and an index alignment error. The spoke angle orientation error may be caused by movement of the spoke region 37 along a radial path. That is, the spoke region 37 may exist at an oblique angle relative to the image for a portion of time in which it passes through the source light beam 24 as best shown in FIG. 8. The spoke angle orientation error as shown in FIG. 8 will be described in greater detail below. Index alignment error may be caused by a limited accuracy of the radial position measurements taken by the image display system 10. Radial position measurements may be used to measure a synchronization of the rotational position of each spoke region 37 relative to the source light beam 24. Tolerance limitations of these radial position measurements may comprise the index alignment error. Therefore, the radial movement of the spoke region 37 and the limited accuracy of the radial position measurements may create a design constraint in which each pixel should be modified when the uncertain region 44 is co-incidental with that particular pixel.

Above the uncertain region 44 is one colorized portion 46 of the source light beam 24 that may present usable light for the image display system 10. Below the uncertain region 44 is another colorized portion 48 of the source light beam 24 that may present usable light for the image display system 10. It may be important to note that FIG. 2 depicts an instantaneous view of the colorized portions 46 and 48 and uncertain region 44. In operation, the uncertain region 44 progresses across the source light beam 24 at a predetermined rate determined by the angular speed of rotation of the color wheel 16. Accordingly, one aspect of the present invention provides a system and method that enables usage of the colorized portions 46 and 48 as the uncertain region 44 progresses through the path of the source light beam 24.

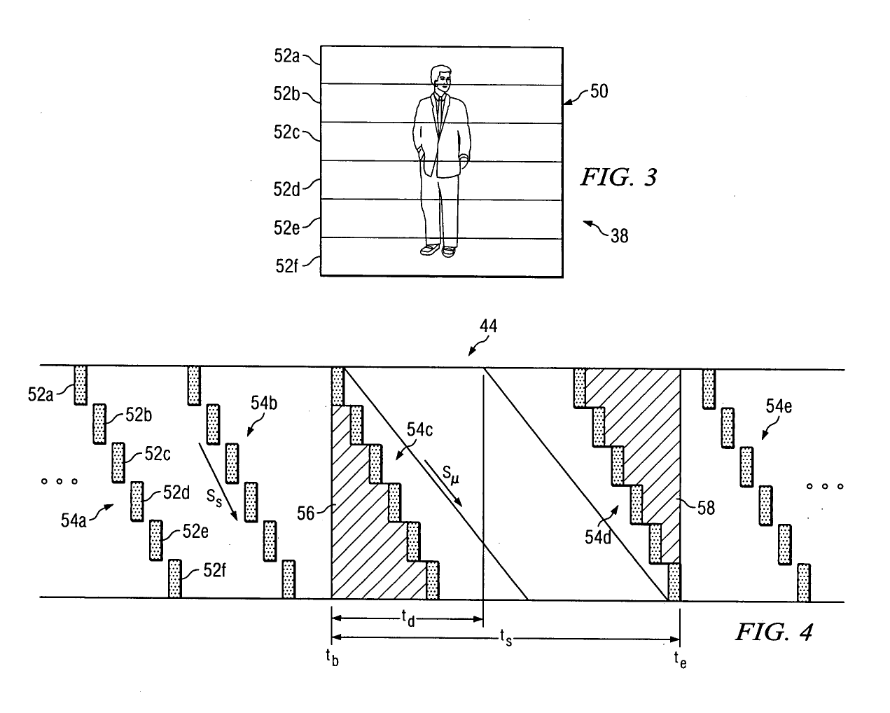

FIG. 3 is an illustrative view showing an image 50 displayed upon the display 38. In one embodiment, the image 50 may be superimposed on the display 38 with image 40. In order to formulate the image 50, the reflective elements of the light modulator 18 may be organized in such a manner to produce several image segments 52. Each segment 52a through 52f may include a number of reflective elements, which are a subset of all reflective elements of the light modulator 18. For example, a light modulator 18 may have a number of spatially disposed reflective elements arranged in a matrix of 1400 columns by 1050 rows. In this case, the light modulator 18 may be said to have an M×N configuration of 1400×1050. Accordingly, the image may be divided into six equivalently sized segments 52, each comprising 1400 columns by 175 rows. Therefore, each segment 52 may have an M×N configuration of 1400×175. The previously provided example describes an image that is organized into six segments; however, it should be appreciated that an image may be divided into any number of segments 52. The embodiment as shown in FIG. 3 shows several segments 52 that each extends horizontally across the image. However, the segments 52 may have any orientation that generally corresponds to the orientation of the uncertain region 44. For example, the embodiment above describes an uncertain region 44 that extends horizontally across the display 38. For this case, each of the segments 52 would also extend across the display 38 in a generally horizontal orientation.

FIG. 4 is a graphical view depicting the sequential order in which each of the segments 52a through 52f may be sequentially updated on the image 50. The horizontal axis is a timeline denoting specific periods in which the segments 52 are updated on the image 50. The graphical view of FIG. 4 also has a number of rows corresponding to each of the segments 52a through 52f. The segments 52 are shown at a relative time period in which they may be periodically updated. All of the segments 52 in image 50 may be delineated into a number of continuously generated phased update sequences 54. Several sample phased update sequences 54a through 54e are shown in FIG. 4. A phased update sequence 54 may include the sequential updating of image information to each segment 52, one after another. Thus, each phased update sequence 54 may represent one instantaneous image 50 that may be displayed upon display 38. A number of phased update sequences 54 may be updated repeatedly during operation of the image display system 10. In one embodiment, the segments 52 of each phased update sequence 54 are updated sequentially from the top to the bottom of the image. The rate at which the segments 52 of a particular phased update sequence 54 are updated may be denoted as a segment skew-rate so.

The uncertain region 44 created by the spoke region 37 is shown representing its traversal across the image. The uncertain region 44 traverses across the image at a rate denoted as the uncertain region skew-rate Sᵤ. The total time required for the uncertain region 44 to traverse through the source light beam 24 begins at a beginning time t_{b} and ends at an end time tₑ. The elapsed time from t_{b} to tₑ is denoted as the total spoke time tₛ. For reasons described above, the uncertain region 44 created by the spoke region 37 requires each of the segments 52 to be temporarily modified. This may be because light within the uncertain region 44 is insufficient in quality to produce the desired image. Conventional implementations of an image display system dealt with this problem by simultaneously turning off all segments 52 during the entire spoke time tₛ. Using this implementation, no portion of the source light beam 24 was used by the system for the entire duration of the spoke time tₛ.

The present invention provides a system and method for synchronizing the updating of each of the segments 52 with the movement of the spoke region 37. In one embodiment, phased update sequences 54 occurring before and after the spoke time tₛ may be synchronized with the beginning time tₛ and end time tₑ of the spoke time tₛ respectively. That is, the image display system 10 may be responsive to the rotational orientation of the spoke region 37 in order to initiate a phased update sequence 52c at spoke time tₛ. In this manner, segments 52 not co-incidental with the uncertain region 44 may continue to direct the colored portion 48 of the source light beam 24 to the image.

In one embodiment, the phased update sequence 54c that is performed prior to the spoke time tₛ may reset or turn off all of the segments 52 according to the normal segment skew-rate sₛ. In another embodiment, the phased update sequence 54c that is performed prior to the spoke time tₛ may modify all of the segments 52 according to the normal segment skew-rate sₛ. The segments 52 may be modified by reducing the relative luminous intensity that is delivered to the light modulator 18 or by turning off the light beam to the segments 52. In one embodiment, segments 52 may be modified by coordinating the modification of segments 52 with other uncertain regions 37. That is, the light provided by several uncertain regions 37 may be coordinated in order to brighten the image or control other aspects of the image such as tint, contrast, color hue, or other aspects of the image 40. In one embodiment, segments 52 within several uncertain regions 37 may be controlled in such a manner to alleviate a so-called ‘gradient effect’. The ‘gradient effect’ is a type of phenomenon that may result due to modification of only one or a portion of the uncertain regions 37. Thus, by coordinating the modification of segments 52 over several uncertain regions 37, the adverse effects of the ‘gradient effect’ may be alleviated.

The image display system 10 may also be responsive to the spoke time tₛ to perform another phased update sequence 54d such that segments 52 not co-incidental with the uncertain region 44 may continue to direct the colored portion 46 of the source light beam 24 to the image during the spoke time tₛ. Region 56 shows an area representing a portion of colored portion 48 that continues to be directed to the image during the spoke time tₛ. Region 58 indicates the area representing a portion of colored portion 46 that continues to be directed to the image during the spoke time tₛ.

The uncertain region skew-rate Sᵤ may be empirically determined during manufacture using any suitable approach. In one embodiment, measurement of the uncertain region skew-rate Sᵤ may be accomplished by measuring a spoke duration time t_{d} and calculating the uncertain region skew-rate Sᵤ based upon the spoke duration time t_{d} and a measured value for the spoke time tₛ. The spoke duration time t_{d} may be referred to as the elapsed time that the uncertain region 44 may occupy any one particular pixel. The spoke duration time t_{d} is shown in FIG. 4. Thus, the spoke duration time t_{d} may directly related to the instantaneous width of the uncertain region 44, which is determined by the design constraints as described above. Thus, the uncertain region skew-rate Sᵤ may be calculated according to the following formula:

$${s}_{u} = \frac{quantity of segments}{{t}_{s} - {t}_{d}}$$

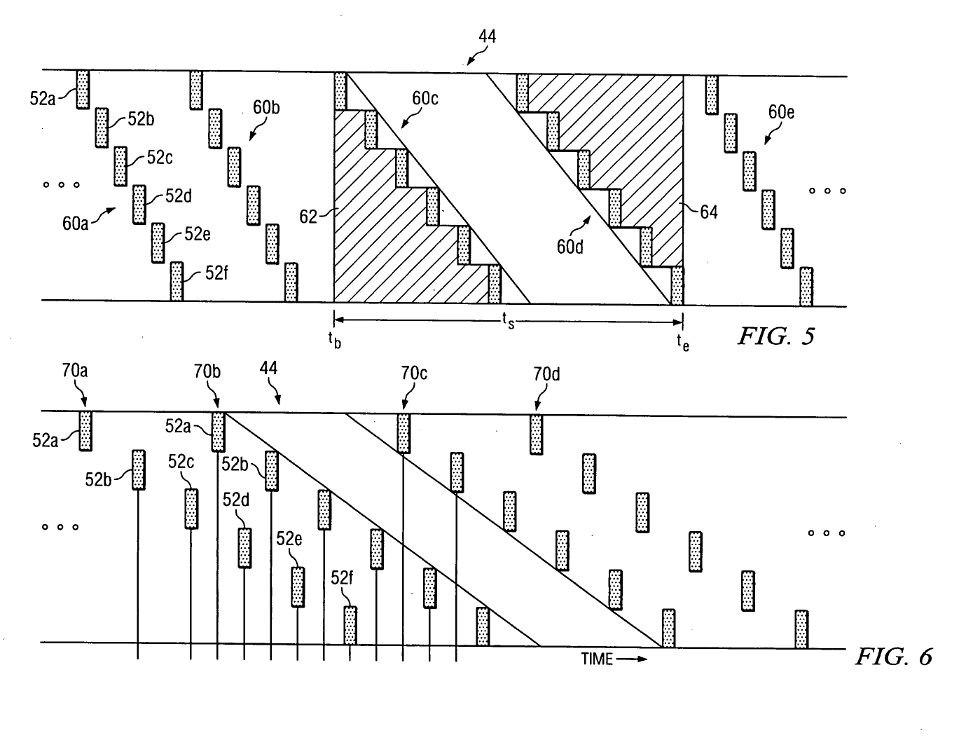

FIG. 5 is a timing diagram showing a method for synchronizing the updating of segments 52 with the spoke time tₛ according to another embodiment of the invention. Efficient use of the source light beam 24 may be further enhanced by making the segment skew-rate sₛ of phased update sequences occurring before and after the spoke time tₛ generally equivalent to the uncertain region skew-rate sᵤ. FIG. 5 shows several instances of phased update sequences 60a through 60e that may be performed on an image display system 10. In this particular embodiment, phased update sequence 60c and 60d are initiated in a similar manner to phased update sequences 54c and 54d of FIG. 4. However, phased update sequences 60c and 60d differ in that their respective sequence skew-rate Sₛ has been adjusted to be generally equivalent to the uncertain region skew-rate sᵤ. In this manner, a relatively larger portion of colored portions 46 and 48 may be utilized during the spoke time tₛ. Region 62 depicts an amount of time in which the segments 52 of the phased update sequence 60c continue to direct colored portion 48 toward the image during the spoke time tₛ. Region 64 depicts an amount of time in which the segments 52 of the phased update sequence 60d continue to direct colored portion 46 toward the image during the spoke time tₛ.

FIG. 6 is a timing diagram showing another embodiment for synchronizing the updating of segments 52 relative to the spoke time tₛ. In this particular embodiment, the segments 52 of each of the phased update sequences 70a through 70d may be interleaved with one another. In this manner, only one segment 52 is updated by the image display system 10 at any one point in time. FIG. 6 shows several examples of phased update sequences 70a through 70d that may be performed on the image display system 10. In this particular embodiment, phased update sequences 70b and 70c are initiated and have a sequence skew-rate Sₛ that is similar to phased update sequences 60c and 60d of FIG. 5. However, this embodiment differs in that all of the phased update sequences 70a through 70d have a generally similar sequence skew-rate sₛ. Additionally, each segment 52 is time-wise spaced apart such that a segment 52 from another phased update sequence 70 may be updated in between. For example, segments 52a and 52b of phased update sequence 70b are updated before and after the segment 52d of phased update sequence 70a respectively. Other segments 52 of each phased update sequence 54 may be processed in a similar manner. Given the segment slew-rate sₛ of this type of phased update sequence 70, the light modulator is only required to update one segment 52 at a time.

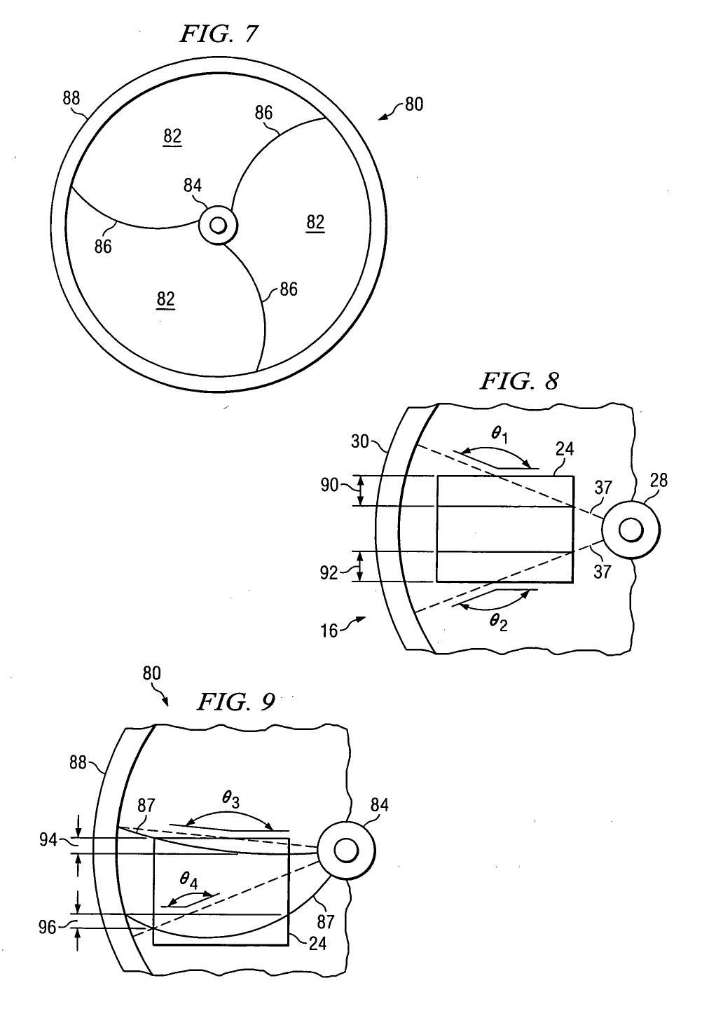

FIG. 7 shows an alternate embodiment of a color wheel 80 that may be used with the image display system 10 of the present invention. The color wheel 80 is generally disk-shaped having three translucent color filter elements 82 that are radially disposed about a hub 84 in a similar manner to the color wheel 16 of FIG. 1B. The color wheel 80 also has an outer ring 88 that extends around the outer periphery of the color wheel 80 in a similar manner to color wheel 16. However, the interfaces 86 of the color wheel 80 differ from the interfaces 34 of color wheel 16 in that the interfaces 86 are each generally slanted in shape. The slanted shape serves the purpose of reducing the spoke angle orientation error as described above. Although FIG. 7 shows interface 86 having a slanted shape that is generally arcuate in shape, it should be appreciated that interface 86 may have any contour that approximates a generally spiral-type shape. Thus for example, the interface 86 may be comprised of a number of linear segments that approximates the slanted shape. The multiple linear segments may provide advantage by being more inexpensive to produce relative to the arcuate shaped interface 34 according to certain embodiments.

FIGS. 8 and 9 show how the spoke angle orientation error may be reduced via implementation of color wheel 80. As shown in FIG. 8, the spoke region 37 of color wheel 16 is shown at varying angular orientations θ₁ and θ₂ with respect to the source light beam 24. At angular orientation θ₁, the spoke region 37 creates a spoke angle orientation error 90. At angular orientation θ₂, the spoke region 37 creates a spoke angle orientation error 92. In this particular embodiment, the hub 28 is disposed to the side of the source light beam 24 approximately equidistant in between the top and bottom of the source light beam 24. Given this relative position, the angular orientation error 90 encountered at the top portion of the source light beam 24 may be generally equivalent to the spoke angle orientation error 92 encountered at the bottom portion of the source light beam 24. FIG. 9 shows how the slanted shape of the interface 86 serves to mitigate the spoke angle orientation error that may be encountered. As shown, spoke region 87 corresponding to interface 86 is shown at various angular orientations θ₃ and θ₄ with respect to the source light beam 24. The hub 84 may also be disposed at an offset vertical position relative to the source light beam 24. Therefore, at angular orientation θ₃, the slanted shape of the spoke region 87 creates a spoke angle orientation error 94. At orientation θ₄, the spoke region 87 creates a spoke angle orientation error 96. Thus, it may be seen that the slanted shape of the interfaces 86 when used in conjunction with the offset vertical offset position of the hub 84 serves to lessen the amount of spoke angle orientation error via radial movement of the interfaces 86 through the source light beam 24.

Although the present invention has been described in several embodiments, a myriad of changes, variations, alterations, transformations, and modifications may be suggested to one skilled in the art, and it is intended that the present invention encompass such changes, variations, alterations, transformations, and modifications as falling within the spirit and scope of the appended claims.

What is claimed is:

1. A method for displaying an image by a digital micro-mirror device, the method comprising:
rotating a color wheel through a source light beam, the color wheel having at least three color filter elements that form at least three corresponding interfaces of each color filter element with an adjacent color filter element, an uncertain region being created near each interface when rotated through the source light beam;
modulating the source light beam into a plurality of image segments, the plurality of image segments being contiguously arranged with one another in order to form the image, each of the plurality of image segments being sequentially updated in one of a plurality of segment update sequences;
initiating a first segment update sequence when the uncertain region begins to move through the source light beam, the first segment update sequence being configured to turn off the plurality of segments; and
initiating a second segment update sequence such that a last image segment is turned on when the uncertain region has completed moving through the source light beam, the second segment update sequence being configured to turn on the plurality of segments.

2. The method of claim 1, wherein each of the interfaces is generally linear in shape.

3. The method of claim 1, wherein each of the interfaces is generally slanted in shape.

4. The method of claim 1, wherein each of the at least three color filter elements have a color that is selected from the group consisting of red, green, blue, yellow, magenta, cyan, ultra-violet, and infrared.

5. A method for displaying an image comprising:
moving a color filter through a source light beam, the color filter having at least two color filter elements that form at least two interfaces, an uncertain region being created by each interface when moved through the source light beam;
modulating the source light beam into a plurality of image segments, the plurality of image segments being contiguously arranged with one another in order to form the image;
modifying the light source light beam to each of the plurality of image segments in a sequential manner when the uncertain region is co-incidental with each particular one of the plurality of image segments.

6. The method of claim 5, wherein modifying each of the plurality of image segments in a sequential manner further comprises turning off each of the plurality of image segments in a sequential manner such that each particular image segment is off at least when the uncertain region is co-incidental with each particular one of the plurality of image segments, and turning on each of the plurality of image segments in a sequential manner when the uncertain region is at least no longer co-incidental with the each particular one of the plurality of image segments.

7. The method of claim 5, wherein modifying each of the plurality of image segments in a sequential manner further comprises modifying each of the plurality of image segments in a coordinated manner with another uncertain region.

8. The method of claim 5, wherein each of the interfaces is generally slanted in shape.

9. The method of claim 5, wherein the at least two color filter elements are at least three color filter elements.

10. The method of claim 9, wherein each of the at least three color filter elements have a color that is selected from the group consisting of red, green, blue, yellow, magenta, cyan, ultra-violet, and infrared.

11. The method of claim 5, wherein the act of modulating the source light beam is accomplished by a digital micro-mirror display.

12. The method of claim 5, wherein the uncertain region and the plurality of image segments extend horizontally across the image.

13. The method of claim 5, and further comprising sequentially updating one of a plurality of segment update sequences, the method further comprising:
modifying the source light beam to each of the plurality of image segments further comprises initiating a first segment update sequence when the uncertain region begins to move through the source light beam; and
initiating a second segment update sequence such that a last image segment is turned on when the uncertain region has completed moving through the source light beam.

14. The method of-Claim 5, wherein:
modifying the source light beam to each of the plurality of image segments further comprises modifying the light source beam to each of the plurality of image segments at a first skew rate, the first skew rate being generally equivalent to a second skew rate, the second skew rate being a speed at which the uncertain region progresses across the image.

15. The method of claim 14, and further comprising calculating the second skew rate by dividing the quantity of segments by a measured spoke time minus a measured spoke duration time.

16. The method of claim 5, and further comprising interleaving a particular update time of each of a first plurality of image segments with a second plurality of image segments.

17. A system for displaying an image comprising:
a color filter having at least two color filter elements that form at least two interfaces, the color filter being configured to move through a source light beam such that each interface creates an uncertain region upon the image; and
a light modulator operable to modulate the source light beam into a plurality of image segments, the plurality of image segments being contiguously arranged with one another in order to form the image;
the light modulator being further operable to modify each of the plurality of image segments in a sequential manner when the uncertain region is co-incidental with each particular one of the plurality of image segments.

18. The system of claim 17, wherein the light modulator is further operable to turn off each of the plurality of image segments in a sequential manner such that the each particular image segment is off at least when the uncertain region is co-incidental with each particular one of the plurality of image segments, and turn on each of the plurality of image segments in a sequential manner when the uncertain region is at least no longer co-incidental with the each particular one of the plurality of image segments.

19. The system of claim 17, wherein each of the interfaces is generally slanted in shape.

20. The system of claim 17, wherein the at least two color filter elements are at least three color filter elements, each of the at least three color filter elements has a color that is selected from the group consisting of red, green, blue, yellow, magenta, cyan, ultra-violet, and infrared.
